(19) United States
(12) Patent Application Publication
(10) Pub. No.: US 2008/0277360 A1
(43) Pub. Date: Nov. 13, 2008

(54) PET BED

(76) Inventor: William David ECKER, Secaucus, NJ (US)

Correspondence Address: STROOCK & STROOCK & LAVAN LLP, 180 MAIDEN LANE, NEW YORK, NY, 10038, US

(21) Appl. No.: 12/117,352

(22) Filed: May 8, 2008

Related U.S. Application Data
(60) Provisional application No. 60/916,751, filed on May 8, 2007.

(51) Int. Cl. A01K 1/015; A47F 7/30

(52) U.S. Cl. 211/28; 119/28.5

(57) ABSTRACT

A system and method for displaying a pet bed at a point of sale location is provided including a display unit for displaying a plurality of mattresses having different volumes and differently sized covers corresponding to the different volume mattresses. The mattresses are preferably displayed at the point of sale location restrained in a compressed state having a reduced volume compared to the expanded state, which preferably reduces the amount of space occupied for the display unit. Furthermore, the variety of sizes of the mattresses and designs of the covers can facilitate a user personalizing the pet bed according to the user's preferences.

### CROSS REFERENCE TO RELATED APPLICATIONS

This application claims the benefit of U.S. Provisional Application No. 60/916,751, filed on May 8, 2007, titled “PET BED,” the contents of which is incorporated in its entirety by reference herein.

### BACKGROUND OF THE INVENTION

This invention relates, in general, to a bed, more specifically to a bed suitable for a pet, such as a dog or cat.

Beds currently available in the market for pets are generally limited to a small selection of beds that are available. The sizes are typically predetermined, as are the color and design. Accordingly, the choices for the consumer are limited, and the number of products that the retailer can display is also limited.

In light of shortcomings described above, it is desirable to provide a bed suitable for a pet that facilitates customization.

### SUMMARY OF THE INVENTION

Generally speaking, the present invention is directed toward a bed product suitable for a pet, such as a dog or cat, wherein the bed includes a mattress component that is compressible into a smaller size for packaging and expandable into a larger size for use. One embodiment of the invention provides a variety of sizes of mattresses wherein the mattresses may be compressed to less than half, preferably less than one third their expanded volume, most preferably less than 15% of the size of the mattress when in use.

In another embodiment of the invention, bed covers are sold separately from the beds, so that where space is limited a store can carry a wide variety of covers and customers can match selected covers to interchangeable beds.

The invention is also directed to a method and system for displaying a pet bed including displaying a variety of sizes of mattresses, covers, accessories and the like, preferably in a single unit.

Accordingly, it is an advantage of the invention to provide a mattress that is compressible into a smaller package than the size of the mattress when in use.

It is further an advantage of the invention to provide a replaceable cover for a mattress to facilitate customization of a bed.

It is also an advantage of the invention to provide a display system for displaying a selection of mattresses and covers for providing various options for a pet bed.

Other objects and features of the present invention will become apparent from the following detailed description, considered in conjunction with the accompanying drawing figure. It is to be understood, however, that the drawings are designed solely for the purpose of illustration and not as a definition of the limits of the invention.

### BRIEF DESCRIPTION OF THE DRAWINGS

Particularly advantageous embodiments of the devices, methods and objects are explained based on the enclosed figures. Here,

FIG. 1 is a perspective view of a bed in accordance with an embodiment of the invention;

FIG. 2 is a perspective view of a bed in accordance with an embodiment of the invention;

FIG. 3A is a perspective view of a mattress removed from a package in accordance with an embodiment of the invention;

FIG. 3B is a perspective view of a package containing a liner in accordance with an embodiment of the invention;

FIG. 3C is a perspective view of a mattress being inserted into a liner in accordance with an embodiment of the invention;

FIG. 4A is a perspective view of a mattress in accordance with an embodiment of the invention;

FIG. 4B is a perspective view of a mattress being rolled up in accordance with an embodiment of the invention;

FIG. 4C is a perspective view of a mattress being inserted into a bag in accordance with an embodiment of the invention;

FIG. 4D is a perspective view of a mattress in a bag in accordance with an embodiment of the invention;

FIG. 4E is a perspective view of the mattress in the bag of FIG. 4D in a compressed state in accordance with an embodiment of the invention;

FIG. 4F is a perspective view of the compressed mattress in the bag of FIG. 4E being inserted into a container in accordance with an embodiment of the invention;

FIG. 5 is a perspective view of a display system in accordance with an embodiment of the invention;

FIG. 6 is a perspective view of a display system in accordance with an embodiment of the invention; and

FIG. 7 is a perspective view of a display system in accordance with an embodiment of the invention.

### DETAILED DESCRIPTION

In accordance with an exemplary embodiment of the invention, a bed suitable for a pet, such as a dog or cat is provided. Preferably, the bed is at least partially customizable, for example, by providing a substantially wide selection of covers and sizes. These covers are presented on display at the store separated from interchangeable beds that can fit into multiple covers. Such options may permit the user to select a bed that best fits the pet and the space in which the bed will be placed, and may further permit the user to find a bed that is most aesthetically pleasing to the user. It also permits a store to stock a larger variety of covers, since the separate covers do not take up as much room as the beds.

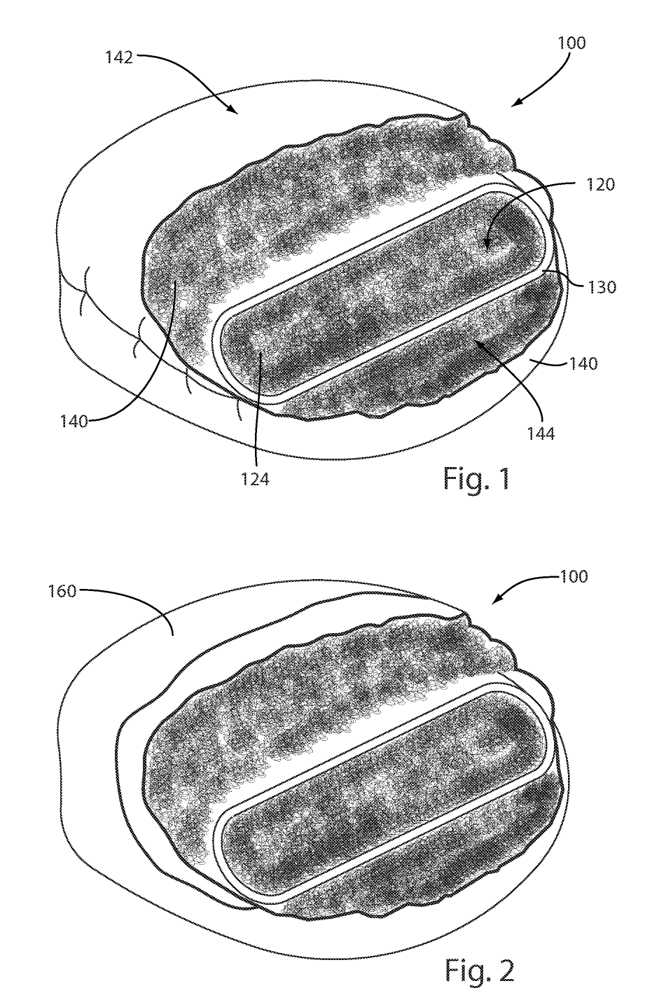

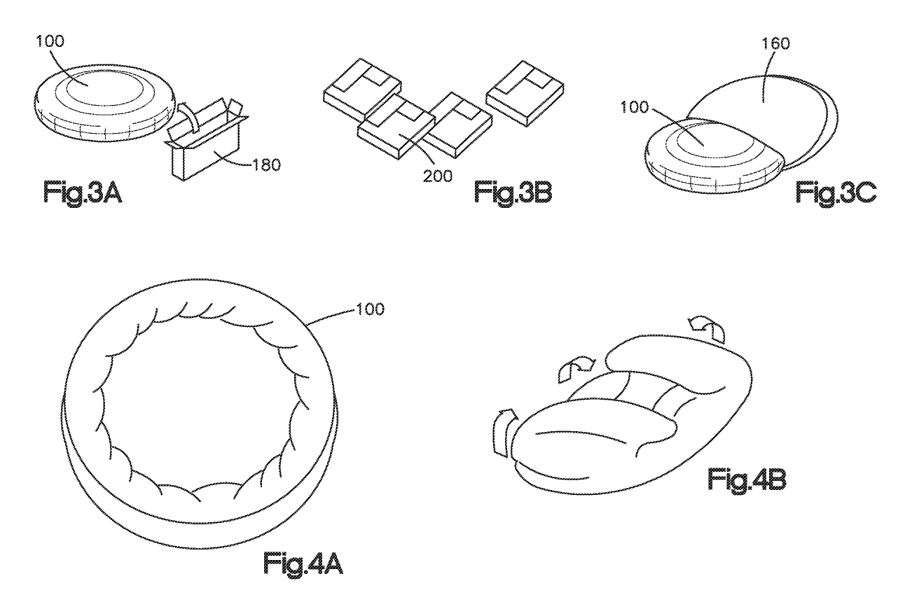

Referring to FIGS. 1-4D, an exemplary embodiment of the invention includes a mattress 100 that is compressible and expandable. More specifically, when packaged for sale, display or transport, mattress 100 may be compressed and maintained sealed in the compressed state. Mattress 100 may be compressed by various methods, such as by the use of rollers, presses, wraps, straps, or other restraining devices, then restrained in the compressed state. Alternatively, mattress 100 may be compressed by placing mattress 100 in an airtight container, such as a plastic bag, and having the air removed from the bag and preferably the mattress. Once compressed, mattress 100 is preferably maintained in the compressed state by a retaining device, by way of non-limiting example, a strap, a wrap, a container such as a box or bag, and the like.

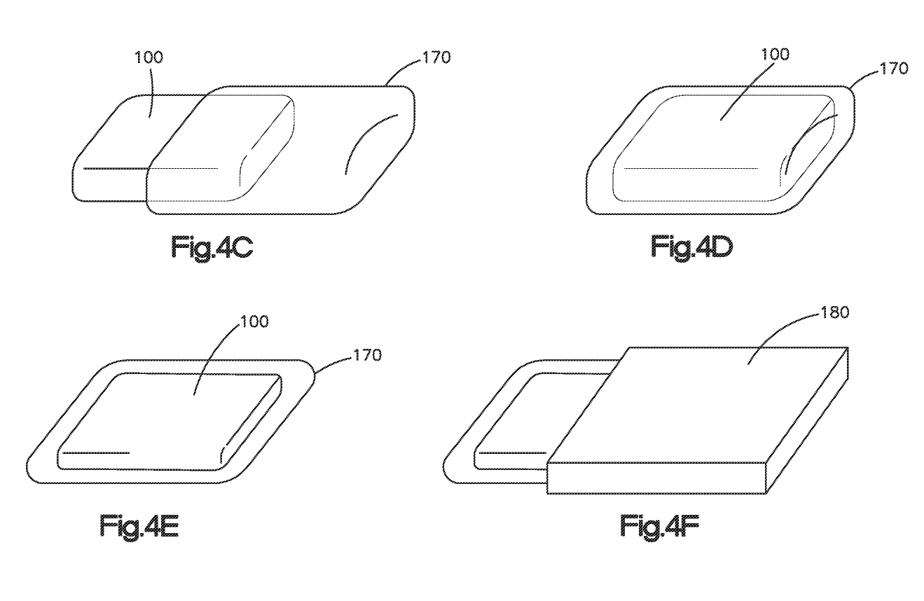

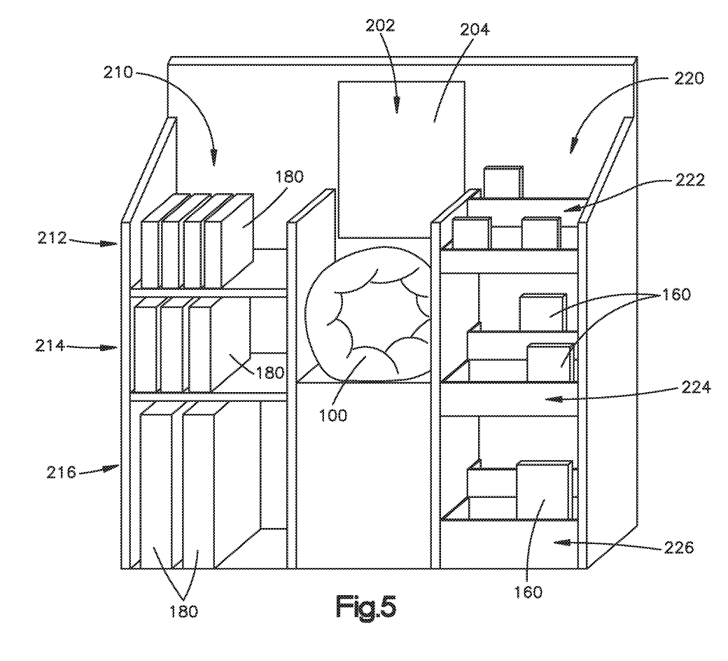

By way of non-limiting example, a process for compressing mattress 100 is illustrated in FIGS. 4A-4E. In FIG. 4A, mattress 100 is illustrated in its expanded state. As shown in FIG. 4B, mattress 100 can be rolled up and inserted into a bag 170 as shown in FIG. 4C. The air from within bag 170 can be removed and bag 170 can be sealed to prevent air from entering bag 170. As the air is removed from bag 170, air is preferably also removed from within mattress 100, thus compressing it.

FIG. 4D illustrates an embodiment of mattress 100 placed within bag 170 prior to being compressed. FIG. 4E shows mattress 100 in bag 170 after being compressed, more specifically, after air has been removed from within bag 170. Preferably, the volume of mattress 100 in the compressed state is approximately 20-25% of the volume of mattress 100 in the expanded state. Because air is prevented from entering bag 170 thereafter, mattress 100 preferably remains in the compressed state. The compressed mattress 100 is preferably further retained in the compressed state by being inserted into a box 180 as shown in FIG. 4F.

One example of a suitable retaining device includes a polyester bag 170, preferably a laminated polyester bag having relatively good barrier properties. Preferably, bag 170 is sealed to prevent the introduction of air into bag 170. Alternatively, a combination of retaining devices may be used. For example, mattress 100 may be sealed in a bag and packaged into a box 180, as a corrugated box, preferably a laminated high grade corrugated box, more preferably a folding box. Mattress 100 may also be strapped in the compressed state and placed into a bag or box, etc. without deviating from the scope of the invention.

Preferably, once the retaining device is removed, for example, by taking mattress 100 out of the container, releasing the straps, etc., mattress 100 can expand to its natural, expanded state. In accordance with one embodiment of the invention, mattress 100 is expanded naturally without the use of an external device. Alternatively, an expanding device may be used. This expanded state is preferably naturally maintained and is further substantially maintained while in use.

In accordance with an exemplary embodiment of the invention, the volume of mattress 100 in the compressed state is approximately 5 to 50% of the expanded state, more preferably approximately 14 to 30%, most preferably approximately 20 to 25%.

Once mattress 100 is in the expanded state, it may be placed on the floor or other desirable surface. In accordance with one embodiment of the invention, mattress 100 is placed directly on the floor. Alternatively, mattress 100 may be placed on or in a support structure such as a basket, a frame, a stand, a housing, etc. without deviating from the scope of the invention.

Referring to FIGS. 1-2, an embodiment of mattress 100 may comprise a covering 142 and a filling 124, 144 retained within covering 142. Preferably, covering 142 comprises a woven or non-woven material, more preferably a non-woven material. Filling 124, 144 preferably comprises fiberfill, foam, viscoelastic materials (“memory foam”), and/or other manmade or natural materials.

In accordance with an embodiment of the mattress illustrated in FIG. 1, mattress 100 may include one or more chambers 120, 140, preferably separated by a divider 130. Whereas divider 130 may comprise a variety of materials, a preferred material for divider 130 includes a flexible material, more preferably a foam material, and most preferably open cell polyurethane foam. Such chambers 120, 140 may facilitate the expansion of mattress 100 once the retaining device is removed, and may further facilitate maintaining mattress 100 in the expanded state. Chambers 120, 140 may also add support for the pet when the pet is lying on mattress 100.

As shown in FIG. 1, divider 130 may define a first chamber 120 therewithin and divider 130 and covering 142 may collectively define a second chamber 140. Alternatively, divider 130 may include one, two or more walls to provide two or more chambers defined by covering 142 and/or divider 130 without deviating from the scope of the invention.

Referring to FIG. 2, mattress 100′ may further include a liner 160, preferably a waterproof liner 160. Liner 160 may be removable or fixed to the covering 142 as a matter of application specific design choice. Liner 160 preferably protects mattress 100′ from wetness, accidents, odors and staining. Liner 160 is preferably washable, thus facilitating keeping the bed clean. It is to be understood that covering 142 may be waterproof in lieu of a separate waterproof lining 160 without deviating from the scope of the invention.

In accordance with an exemplary embodiment of the invention, liner 160 is removable, thus providing the user with flexibility in decorating the bed. Preferably, a relatively wide selection of liners 160 is made available for aesthetic purposes. For example, the selection of liners 160 may include different colors, patterns, fabric, etc., which may facilitate customizing the bed according to the needs and wants of the user and/or pet. Furthermore, a plurality of liners 160 may be used to change the look of the bed by alternating the liners by season to match the draperies and the like, at the whim of the user.

Additionally, because only liner 160 is replaced, the cost of changing the appearance of the bed is reduced compared to replacing the bed entirely. Moreover, because liner 160 may be washed independently from mattress 100, liner 160 may be washed more often, which may be beneficial for the health of the pet as well as the air quality of room in which the bed is located.

Referring to the embodiments illustrated in FIGS. 5-7, a distributor, such as a retailer, pet store, etc., may provide a variety of sizes of mattresses and liners as well as a relatively wide selection of liners in a single display area, rack or system 200. By providing mattresses 100 and 100′ in the compressed state, a wider selection of mattress sizes may be provided in the same shelf space typically used to display mattresses readily available in the market. Therefore, the compressed mattresses can increase the efficiency in which display areas, such as shelving, as well as storage space, such as warehouses, are used. Reducing the area necessary to display or store the mattresses may also reduce the cost of distributing, storing, or selling the mattresses. Therefore, providing mattresses in the compressed state will preferably reduce distribution and inventory costs compared to the presently available mattresses that are sold in their natural state. Preferably, the mattresses in the compressed state are packaged in boxes of similar size and shape regardless of the size of the mattress, thus providing uniformity and facilitating displaying the mattresses. Alternatively, the mattresses may be sold with the retaining device, such as a bag, without a separate packaging.

Referring to FIGS. 5-7, a display system 200, 300, 400 in accordance with certain embodiments of the invention may include one or more columns preferably having a plurality of shelves. In FIG. 5, display system 200 includes a first column 210 having three shelves 212, 214, 126, and a second column 220 having three shelves 222, 224, 226. As shown, the first column 210 may be used to hold boxes of mattresses 100 whereas the second column 220 may be used to hold the various liners 160 for mattresses 100. The different shelves 212, 214, 216 of the first column 210 may be used to hold mattresses 100 of different sizes. Likewise, shelves 222, 224, 226 of second column 220 may be used to hold liners 160 of the different size mattresses 100. For example, a top shelf 212, 222 may hold the small mattresses/liners, a middle shelf 214, 224 may hold the medium sized mattresses/liners, and a bottom shelf 216, 226 may hold the large mattresses/liners.

Preferably, the mattresses and liners are color-coded. For example, the small mattresses and liners may have a red label whereas the large mattresses and liners may have a blue label. Accordingly, a user may relatively easily select the mattress size and liner to meet the specific need or want of the user and/or pet. Moreover, the compressed mattress may facilitate transporting the mattress home from the store.

In accordance with an exemplary embodiment, a display column 202 may be provided to display a mattress 100 in the expanded state, preferably covered with a liner 160. In the embodiment shown in FIG. 5, display column 202 may be provided between first and second columns 210, 220. A graphic display 204 may be provided illustrating the various features of the bed. Additionally, a graphic description of the bed system may also be provided on the display system, for example, proximate the top of the unit.

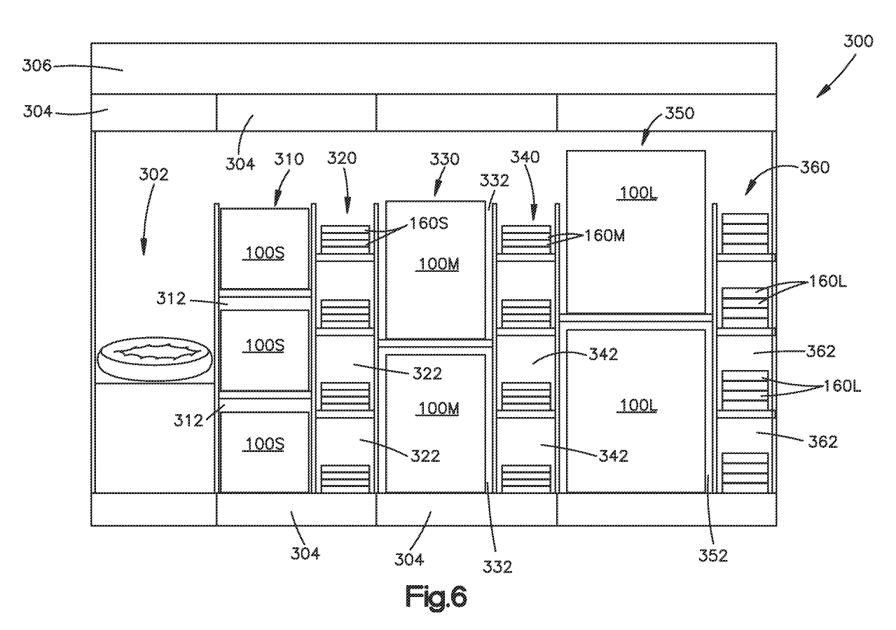

Referring to FIG. 6, an embodiment of the display system 300 includes seven columns. A display column 302 can be provided in which a sample mattress 100 can be displayed, preferably in the expanded state. Two columns can be provided for each size being displayed, one for mattresses 100 and one for liners 160. In the embodiment shown, small, medium, and large sized mattresses 100 can be provided, in its respective packaging 100S, 100M, 100L, in respective columns 310, 330, 350. Likewise, liners 160 for each size mattress 100 can also be provided, in its packaging, it respective columns 320, 340, 360.

Each column 310, 320, 330, 340, 350, 360 can include one or more shelves 312, 322, 332, 342, 352, 362 on which mattresses 100 or liners 160 can be provided. Preferably, the different liner shelves 322, 342, 362 provide different styles of liners separated by color, fabric, pattern, etc. A plurality of displays 304 can be provided, preferably identifying the size provided above or below the display 304. Another display 306, such as a graphic description of the system can also be provided, for example, spanning across multiple columns of display system 300.

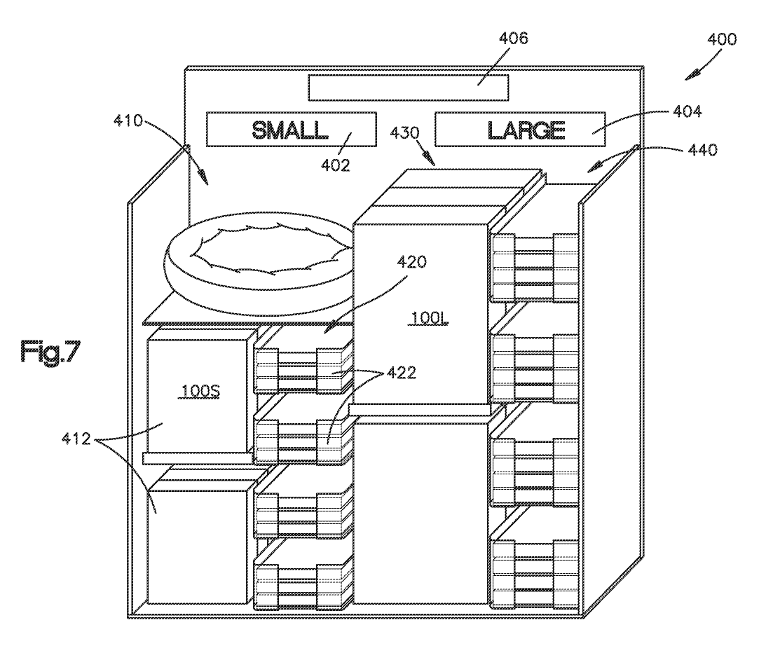

Reference is made to FIG. 7, wherein an embodiment of display system 400 is illustrated having a sample display 402 above two columns 410, 420 rather than providing a separate column for the sample display. As shown, the small sized mattresses 100S and its corresponding liners 160 can be provided in one or more shelves 412, 422 of columns 410, 420. Another pair of columns 430, 440 can be provided for displaying large sized mattresses 100L and corresponding liners 160. A size identifying display 404 can be provided, as well as a display 406 for the bed system, above columns 410, 420, 430, 440.

It is to be understood that mattress 100 may comprise a variety of shapes without deviating from the scope of the invention. For example, whereas a generally round mattress is illustrated herein, the mattress may have a generally rectangular shape, a hexagonal shape, etc., without deviating from the scope of the invention.

Whereas a variety of sizes and shapes are contemplated, one example of a range of sizes of the mattress in the expanded state includes a “large” may have a diameter of about 44 inches. Preferably, a large in the compressed state can fit into a container such as a box having a width of about 15 in and a height of about 20 in.

Additionally, the bed may include, by way of non-limiting example, scotch guard for stain protection, anti-microbial fiber fill that inhibits growth of known pet allergens, cedar wood chips for natural odor control, etc. as a matter of application specific design choice.

Moreover, whereas the bed has been described herein as suitable for a pet, it is contemplated that the bed may be suitable for people without deviating from the scope of the invention. For example, the bed may be a bed for people, a seat cushion, and the like, without deviating from the scope of the invention.

A method of providing a bed suitable for a pet is also provided herein. In accordance with an embodiment of the invention, one may provide a compressible mattress which can be compressed and expanded, wherein the mattress can preferably maintain its expanded state naturally. The mattress may be compressed from its expanded state into a compressed state, preferably to between 14-30% of the volume of the mattress in the expanded state. The mattress may be compressed by applying pressure on the mattress and restraining it. Alternatively, the mattress may be placed into a bag and the air from within the bag and the mattress may be removed. The mattress may then be restrained in the compressed state, for example, by sealing the mattress in a bag, such as a polyester bag. The compressed mattress may be shipped, distributed, sold, etc. utilizing a variety of packaging, for example, in a sealed bag, in a corrugated box, or both.

In accordance with an exemplary embodiment, a plurality of sizes of mattresses may be provided. Furthermore, a variety of liners for covering the mattresses may also be provided. Preferably, the liners are washable and waterproof. In accordance with FIGS. 5-7, the compressed mattresses and liners may be displayed in a display system facilitating the user to select the necessary mattress and liner from a single unit. Preferably, the different sizes may be color coded to facilitate the experience. A full covered, expanded mattress may also be displayed, preferably identifying the various features, which may further facilitate the process for the user. A graphic description of the system may also be provided, preferably proximate the top of the display system.

Thus, while there have been shown and described and pointed out novel features of embodiments of the present invention, materials, dimensions, it will be understood that various omissions and substitutions and changes in the form and details of the disclosed invention may be made by those skilled in the art without departing from the spirit of the invention. For example, the shape, size of the mattress, the number of dividers, the number and type of retaining devices used to maintain the mattress in the compressed state, the number and arrangement of columns and shelves of the display system, etc. can be varied without deviating from the scope of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. A system for displaying a pet bed at a point of sale location, comprising:
a plurality of mattress sized, configured, dimensional and made of materials suitable for use as a pet bed;
display unit retaining one or more first mattresses in a compressed state, the first mattress having a first compressed volume when in the compressed state and a first expanded volume when in an expanded state, the first expanded volume being greater than the first compressed volume;
the display unit retaining one or more second mattresses in a compressed state, the second mattress having a second compressed volume when in the compressed state and a second expanded volume larger than the first expanded volume when in an expanded state, the second expanded volume being greater than the second compressed volume;
the unit retaining a plurality of first covers sized to substantially cover the first mattresses in the expanded state wherein the plurality of first covers includes two or more varieties of the first covers, each having a different appearance; and
the display unit retaining a plurality of second covers sized to substantially cover the second mattresses in the expanded state;
wherein the plurality of second covers includes two or more differently appearing second covers.

2. The system of claim 1, further comprising a sample display unit retaining a sample mattress in an expanded state.

3. The system of claim 1, further comprising a sample display unit retaining a sample mattress in an expanded state and a cover substantially covering the sample mattress.

4. The display unit of claim 1, comprising separate compartments for the differently sized mattresses and for the differently appearing covers.

5. A system for displaying a pet bed, the system comprising:
a display rack sized and configured for use as a point of sale display;
a plurality of mattresses restrained in a compressed state of reduced volume compared to mattresses in an unrestrained expanded state, the mattresses sized and made of materials and of dimensions suitable for use as a pet bed; and
a plurality of differently appearing covers constructed and arranged to substantially cover the mattress, the mattresses displayed separately from the covers, wherein the plurality of covers comprise a variety of liners having different designs.

6. The system of claim 5, wherein the plurality of mattresses comprises mattresses of varying volume in the compressed state and the covers are in different sizes, corresponding to the mattresses of varying volume, wherein the mattresses have an expanded state having a volume than the volume of compressed state.

7. The system of claim 6, wherein the compressed state has a volume of about 5 to 50% of the volume of the expanded state.

8. The system of claim 6, wherein the compressed state has a volume of about 14 to 30% of the volume of the expanded state.

9. The system of claim 6, wherein the compressed state has a volume of about 20 to 25% of the volume of the expanded state.

10. The system of claim 5, wherein the mattress includes a plurality of chambers, and a divider formed of flexible material dividing the mattress into a plurality of chambers.

11. The system of claim 10, wherein the divider comprises a foam material.

12. The system of claim 5, wherein the cover comprises a non-woven material.

13. The system of claim 5, wherein the mattress comprises at least one of fiberfill, foam, viscoelastic materials, or any combination thereof as a filling material.

14. The system of claim 5, further comprising a retaining device for retaining the mattress in the compressed state.

15. The system of claim 14 wherein the retaining device is a bag, sealed to prevent the ingress of air.

16. The system of claim 14, wherein the retaining device is a box.

17. The system of claim 5, further comprising instructions associated with the mattresses indicating that the mattresses should be used as a pet bed.

18. The system of claim 5, wherein the mattresses and covers are color-coded, wherein a mattress and a cover having a common size may be provided in packages having a common color provided thereon.

19. A bed for a pet, the bed comprising:
a mattress sized and made of materials and of dimensions suitable for use as a pet bed;
the mattress having a compressed state and an expanded state;
a restraining device for maintaining the mattress in the compressed state;
wherein the mattress expands on its own resiliency when the restraining device is removed from the mattress, wherein the inner chamber expands before the outer chamber expands;
instructions associated with the mattress indicating that the mattress should be used as a pet bed; and
a cover separate from the mattresses, the cover sized to receive the corresponding mattress therein.

20. The bed of claim 19, wherein the mattress includes an inner chamber, an outer chamber, and a divider separating the inner chamber from the outer chamber.

21. A method of displaying a pet bed system in a store, comprising:
providing at least one pet bed suitable for a pet in a store;
the pet bed comprising a mattress having an expanded volume in the expanded state and compressing the mattress to a compressed state having a compressed volume being less than half the expanded volume;
restraining the mattress to maintain the mattress in the compressed state;
displaying a plurality of covers constructed and arranged to substantially cover the one or more mattress in the expanded state.

22. The method of claim 21, comprising:
providing a first display unit constructed and arranged to retain one or more first mattresses in the compressed state;
the second display unit constructed and arranged to retain one or more second mattresses in a compressed state, the second mattress having a second compressed size when in the compressed state and a second expanded size larger than the first expanded size when in an expanded state;
the third display unit constructed and arranged to retain one or more first covers sized to substantially cover the first mattress in the expanded state; and
one or more fourth display units constructed and arranged to retain one or more second liners sized to substantially cover the second mattress in the expanded state.

23. The display method of claim 22, further comprising:
the fifth display unit constructed and arranged to retain one or more third mattresses in a compressed state, the third mattress having a third compressed size when in the compressed state and a third expanded size larger than the second expanded size when in an expanded state; and
the display unit constructed and arranged to retain one or more third covers sized to substantially cover the third mattress in the expanded state.
